(19) United States
(12) Patent Application Publication
(10) Pub. No.: US 2009/0000147 A1
(43) Pub. Date: Jan. 1, 2009

(54) INTERACTIVE DRIER UNIT

(75) Inventor: Peter COLLINS, Witney (GB)

Correspondence Address: DAVIS BUJOLD & Daniels, P.L.L.C., 112 PLEASANT STREET, CONCORD, NH, 03301, US

(73) Assignee: Airdri Limited, Witney (GB)

(21) Appl. No.: 12/147,687

(22) Filed: Jun. 27, 2008

(30) Foreign Application Priority Data
Jun. 29, 2007 (GB) 0712728.5

(51) Int. Cl. A47K 10/48; F26B 3/04; F26B 21/00

(52) U.S. Cl. 34/565; 34/582; 34/585

(57) ABSTRACT

A drier unit comprising a housing with an air inlet and an air outlet, a flow duct through the housing linking the air inlet to the air outlet; a fan disposed in the flow duct so as to displace air along the duct from the inlet to the outlet characterised in that the air outlet includes more than one outlet aperture, each aperture being directed to provide for the passage of air into a drying region adjacent the housing, air flow from one aperture being caused to interact with air flow from another aperture to generate swirling of air in the drying region. The invention further envisages means providing for air flow through the apertures to be coupled so that in the event of one or some of the apertures being blocked flow through the remaining unblocked aperture or apertures is increased.

This application claims priority from British Application Serial No. 0712728.5 filed Jun. 29, 2007.

### TECHNICAL FIELD

This invention relates to a drier unit. It is particularly, though not exclusively, concerned with a drier for use in a wash room for use by an individual for hand drying. Such a drier is widely used and provides for automatic operation when, for example, a pair of hands is detected by the drier in a region adjacent the drier. Such a drier is conveniently located on a wall in a wash room or other location.

### BACKGROUND ART

A typical drier unit is made up of a housing enclosing a fan drivable by an electric motor, a heater and a passage for air through the casing from an inlet through which ambient air is drawn by the fan for subsequent emission from an outlet. While passing through the passage the displaced air has heat transferred to it by the heater. The housing further contains components for regulating operation of the fan and heater and for detecting the presence of hands at a location outside the casing in the vicinity of the outlet.

### DISCLOSURE OF INVENTION

According to the present invention there is provided a drier unit comprising a housing with an air inlet and an air outlet, a flow duct through the housing linking the air inlet to the air outlet; a fan disposed in the flow duct so as to displace air along the duct from the inlet to the outlet characterised in that the air outlet includes more than one outlet aperture, each aperture being directed to provide for the passage of air into a drying region adjacent the housing, air flow from one aperture being caused to interact with air flow from another aperture to generate swirling of air in the drying region.

According to a first preferred version of the present invention the flow duct provides for air flow along the duct to generate a source of pressurised air upstream of, and common to all or the majority of outlet apertures, so that in the event of one outlet aperture being obstructed the source of pressurised air is enabled to flow through the remaining aperture or apertures.

According to a second preferred version of the present invention the flow duct provides for air flow along the duct to a first one, or a first group of some, of the outlet apertures and at least one further flow duct through the housing linking the air inlet to the air outlet; the or each further air duct providing for further air flow along the further duct or each further duct from the inlet to a second or second group of the outlet apertures.

According to a third preferred version of the present invention or of any preceding preferred version thereof the drier unit has an air outlet with two apertures. Typically the drier includes a region upstream of the apertures common to both apertures the region being adapted for feeding with air from the, or all, flow ducts.

Alternatively the drier provides for each aperture to be fed by way of a flow duct exclusive to the aperture.

### BRIEF DESCRIPTION OF DRAWINGS

An exemplary embodiment of the invention will now be described with reference to the accompanying diagrammatic views of a drier unit of which:

FIG. 1 is a diagrammatic view from the front and to one side and with the front cover removed to show the internal disposition of components with the drier in standby configuration;

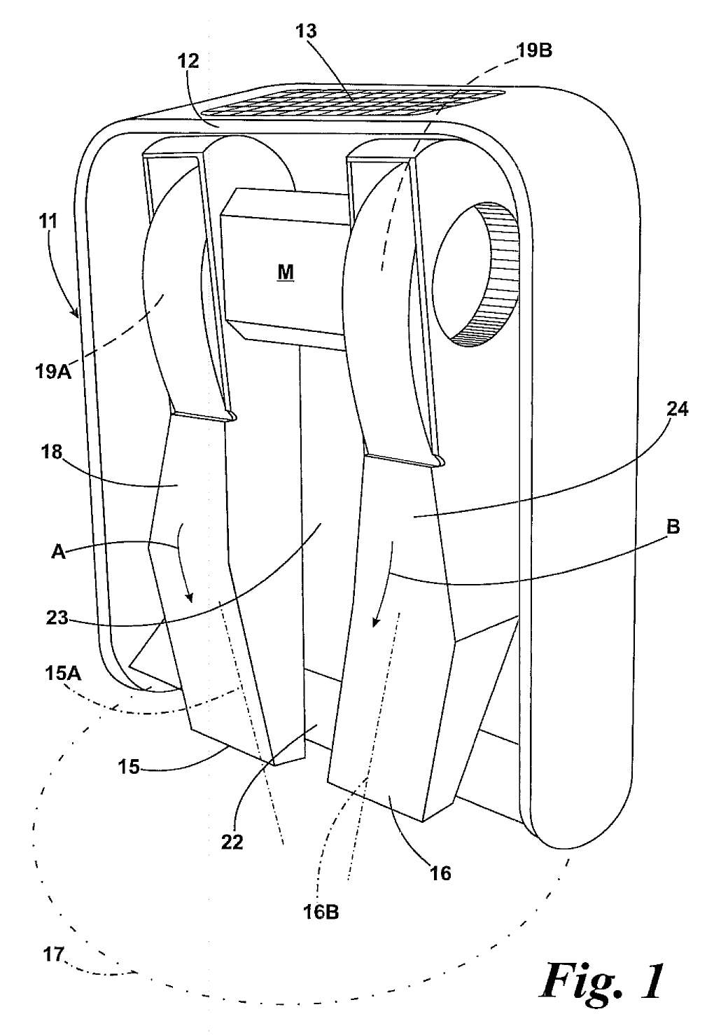

FIG. 2 is a diagrammatic view from the front and to one side and with the front cover removed to show the internal disposition of components with the drier in working configuration;

The embodiment shows a drier having an outside dimension which can be varied as described in our co-pending application GB 0712727.7.

### MODE FOR CARRYING OUT THE INVENTION

The drawing shows a drier unit 11 with a housing 12 having a front panel which is not shown. The housing 12 incorporates an air inlet 13 and an air outlet comprising a pair of apertures 15, 16. For other applications more than two apertures can be used. The apertures 15, 16 open into a drying area 17 beneath the housing 12. The apertures 15, 16 each have a flow axis, respectively axis 15A, 16A along which air is caused to flow through the associated aperture.

The air inlet 13 and air aperture 15 are linked within the housing by a duct 18 in which a fan 19A, drivable by motor M, is located to provide for driving of air along the duct 18 in the direction of arrow A towards the air outlet 15.

The drier unit 11 also incorporates a proximity sensing device 22 and control means 23. The proximity device 22 serves to detect the insertion of an object, such as a pair of hands, into the drying area 17. A drying cycle is then initiated by way of the control means 23 in which cycle the fan 18 is operated causing in air to be driven along the duct 18 from the air inlet 13 to the air outlet 15. In passing along the duct 18 the air is heated by an electrical element (not shown) with a resulting provision of hot air into the drying area 1 emitted from the apertures 15.

The air inlet 13 and air aperture 16 are linked within the housing by a duct 24 in which a further fan 19B, also drivable by motor M, is located to provide for driving of air along the duct 24 in the direction of arrow A towards the air outlet 16.

The axis 15A, 16A are so directed that the air outputs A1m A2 from, respectively, the apertures 15, 16 interact peripherally to generate vortices in the drying area 17. The main body of heated air flow has sufficient kinetic energy to displace water and vapour from the surface of the object while the vortices considerably enhance the drying effect. The effect of enhancement has been found to both improve on the conventional drying cycle available from existing drier types and also to provide a comfortable physiological effect.

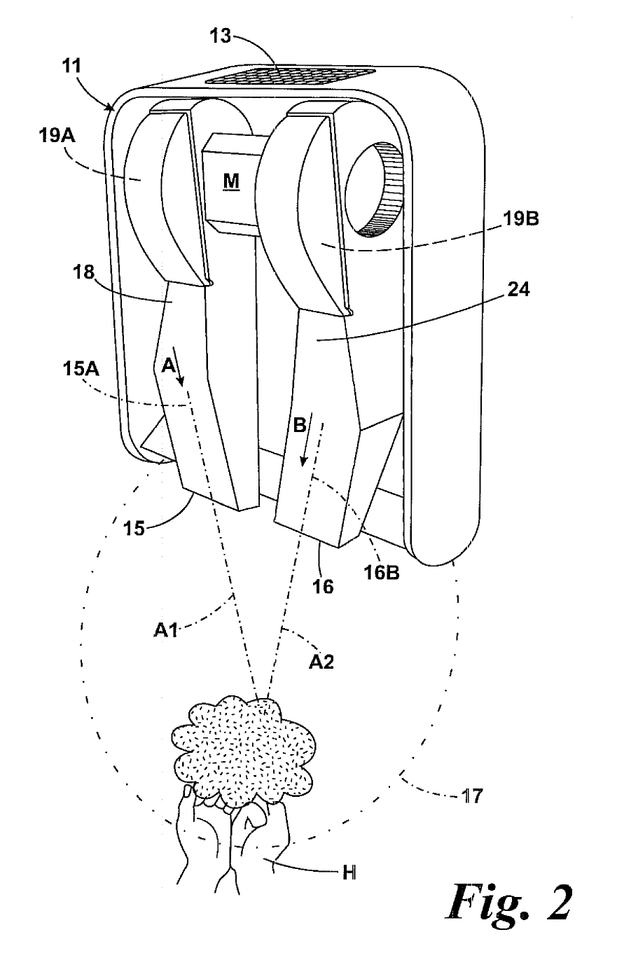

FIG. 2 shows the drier 11 in operation with wet hands H of a user positioned in the drying area 17 to receive air heated streams A1 and A2 from, respectively, apertures 15, 16. Once the programmed drying cycle is competed and the hands H removed the drier 11 automatically reverts to its stand by mode.

In the event one of aperture 15, 16 is blocked then the motor M tends to speed up so that the flow from the unblocked aperture is increased. Consequently it has been found that the drying action is not seriously prejudiced. In the event the blockage is removed the normal drying function is restored automatically.

The exemplary embodiment makes use of two apertures 15, 16. However the invention envisages the use of more than two apertures in a given application to provide a required interaction of air flows in the drying area 17.

In an alternative embodiment rather than having each aperture fed exclusively by a duct it is envisaged that a plenum chamber could be provided in the casing 12 immediately upstream of the apertures so as to provide a common source of drying air to all the outlets (regardless of number). Such a plenum chamber can be fed by one or more fans.

### INDUSTRIAL APPLICABILITY

The present invention provides for a drier unit, typically for a wash room, by means of which a plurality of air flows are caused to impinge on one another in a drying region of the unit to generate vortices to enhance the drying of hands or other articles placed in the drying region. The present invention is conveniently combined with that of our co-pending application GB 0712727.7 which provides a version of a heater unit which reduces itself in size when not in use.

1.-7. (canceled)

8. A drier unit comprising:
a housing with an air inlet and an air outlet,
a flow duct through the housing linking the air inlet to the air outlet;
a fan disposed in the flow duct so as to displace air along the duct from the inlet to the outlet,
wherein the air outlet includes more than one outlet aperture, each outlet aperture being directed to provide for the passage of air into a drying region adjacent the housing, and air flow from one aperture being caused to interact with air flow from another aperture to generate swirling of air in the drying region.

9. The drier unit according to claim 8, wherein the flow duct provides for air flow along the duct to generate a source of pressurised air upstream of, and common to at least a majority of outlet apertures, so that in the event of one outlet aperture being obstructed, the source of pressurised air is enabled to flow through the remaining aperture or apertures.

10. The drier unit according to claim 8, wherein the flow duct provides for airflow along the duct to a first one, or a first group of some, of the outlet apertures and at least one further flow duct through the housing linking the air inlet to the air outlet; and the or each further air duct providing for further air flow along the further duct or each further duct from the inlet to a second or second group of the outlet apertures.

11. The drier unit according to claim 8, wherein the drier unit has an air outlet with two apertures.

12. The drier unit according to claim 11, wherein including a region upstream of the apertures common to both apertures the region being adapted for feeding with air fed are fed from the or all flow ducts.

13. The drier unit according to claim 11, wherein each aperture is adapted for feeding from a flow duct exclusive to the aperture.

14. The drier unit as hereinbefore described with reference to the accompanying drawing.
